(19) United States
(12) Patent Application Publication
(10) Pub. No.: US 2016/0357453 A1
(43) Pub. Date: Dec. 8, 2016

(54) SEMICONDUCTOR MEMORY DEVICE

(71) Applicant: SK hynix Inc., Gyeonggi-do (KR)

(72) Inventor: Sung-Ho KIM, Gyeonggi-do (KR)

(21) Appl. No.: 14/936,820

(22) Filed: Nov. 10, 2015

(30) Foreign Application Priority Data
Jun. 4, 2015 (KR) 10-2015-0079115

(51) Int. Cl. G06F 3/06; G06F 13/16

(52) U.S. Cl. CPC G06F 3/0611; G06F 3/0629; G06F 3/0673; G06F 13/16

(57) ABSTRACT

A semiconductor memory device includes a data input/output unit suitable for storing a plurality of pieces of data in a plurality of bank areas through a first data bus and a second data bus, and outputting the plurality of pieces of data to an external data pin from the plurality of bank areas; and a plurality of unit banks each including a first bank area which stores data corresponding to a lower bit of a bit group to be first inputted/outputted though the first data bus, and a second bank area which stores data corresponding to an upper bit of the bit group to be inputted/outputted though the second data bus after input/output of the data corresponding to the lower bit.

### CROSS-REFERENCE TO RELATED APPLICATIONS

The present application claims priority of Korean Patent Application No. 10-2015-0079115, filed on Jun. 4, 2015, which is incorporated herein by reference in its entirety.

### BACKGROUND

1. Field

Exemplary embodiments of the present invention relate to a semiconductor design technology, and more particularly, to a semiconductor memory device that performs a read operation.

2. Description of the Related Art

Semiconductor memory devices, particularly DRAM, DDR3, and DDR4 operate in synchronization with a clock according to dynamic on-die termination (DODT) when a write command is inputted during a write operation. Furthermore, the semiconductor memory devices may operate in clock synchronization according to normal on-die termination (ODT) when an ODT command is inputted. Furthermore, the semiconductor memory device may operate in clock synchronization according to CAS write latency (CWL) and read latency (RL) of a mode register set (MRS), in which data is output when read data is input. In this case, the read latency (RL) is indicated by the sum of additive latency (AL) and CAS latency (CL).

In the semiconductor memory device, during the read operation, 8 pieces of continuous data may be outputted (for example). The time from when a read command is input until data is first output is called the read latency (RL). The read latency may include a command generation time, a command and control signal transfer time from an exterior source to a bank, the bank operation time, the time for outputting data from the bank to an external data pad, and the like.

A typical semiconductor memory device may include a plurality of memory banks in which data is stored. The memory banks may be arranged at different distances from the control block, which controls the input of commands and data. Since each of the banks are at a different distance from the control block, it takes a different amount of time for each bank to output data during a read operation. In other words, the banks have different read latencies.

### SUMMARY

Various embodiments are directed to a semiconductor memory device capable of performing a high speed read operation by reducing read latency.

In an embodiment, a semiconductor memory device may include: a data input/output unit suitable for storing a plurality of pieces of data in a plurality of bank areas through a first data bus and a second data bus, and outputting the plurality of pieces of data to an external data pin from the plurality of bank areas; and a plurality of unit banks each including a first bank area which stores data corresponding to a lower bit of a bit group to be first inputted/outputted though the first data bus, and a second bank area which stores data corresponding to an upper bit of the bit group to be inputted/outputted though the second data bus after input/output of the data corresponding to the lower bit, wherein the first bank area of each of the plurality of unit banks is adjacent to the data input/output unit as compared with the second bank area of each of the plurality of unit banks.

The semiconductor memory device may further include a bank control unit suitable for controlling each of the first and second bank areas to output the data corresponding to the lower bit and the upper bit to the data input/output unit, or to receive data from the data input/output unit.

The bank control unit may include a sense amplification unit suitable for sensing a level of data stored in a corresponding bank area and transferring the sensed data to the data input/output unit during the read operation.

The bank control unit may include a write driver suitable for writing data received from the data input/output unit in a corresponding bank area during a write operation.

The semiconductor memory device may further include a command decoding unit suitable for generating a column access signal corresponding to a corresponding unit bank in response to a read command or a write command.

In another embodiment, a semiconductor memory device may include: a data input/output unit suitable for storing a plurality of pieces of data in a plurality of bank areas through a first data bus and a second data bus, and outputting the plurality of pieces of data to an external data pin from the plurality of bank areas; a first bank area arranged at a first distance from the data input/output unit, and suitable for storing data corresponding to a first bit of a first bit group though the first data bus; a second bank area arranged at a second distance from the data input/output unit, and suitable for storing data corresponding to a first bit of a second bit group though the first data bus; a third bank area arranged at a third distance from the data input/output unit, and suitable for storing data corresponding to a second bit of the first bit group though the second data bus; and a fourth bank area arranged at a fourth distance from the data input/output unit, and suitable for storing data corresponding to a second bit of the second bit group though the second data bus, wherein the first to fourth distances are greater in order and the data corresponding to the first bit of the first and second bit groups includes data that is first inputted/outputted.

The first and third bank areas may be included in a first unit bank.

The second and fourth bank areas may be included in a second unit bank.

The first bit of the first and second bit groups may be a lower bit of the corresponding bit group.

The second bit of the first and second bit groups may be an upper bit of the corresponding bit group.

Each of the first to fourth bank areas may include a bank control unit suitable for controlling data corresponding to the first bit group and the second bit group to be outputted to the data input/output unit, or controlling data to be received from the data input/output unit.

The bank control unit may include a sense amplification unit suitable for sensing data stored in a corresponding bank area and transferring the sensed data to the data input/output unit during the read operation.

The bank control unit may include a write driver suitable for writing data received from the data input/output unit in a corresponding bank area during a write operation.

The first and second bank areas may output the data corresponding to the first bit of the first and second bit groups before the data corresponding to the second bit of the first and second bit groups.

The semiconductor memory device may further include a command decoding unit suitable for generating a column access signal to a corresponding unit bank in response to a read command or a write command.

In another embodiment, a semiconductor memory device may include: a plurality of unit banks each including first and second bank areas storing first and second pieces of data, respectively; and a data transfer unit suitable for transferring the first and second pieces of data between the unit banks and an external data pin, wherein the second piece of data is read out subsequently to the first piece of data, wherein the first bank area is adjacent to the data input/output unit, and wherein the second bank area is relatively far from the data input/output unit.

In another embodiment, a semiconductor memory device may include: a plurality of unit banks each including first and second bank areas storing first and second pieces of data, respectively; and a data transfer unit suitable for transferring the first and second pieces of data between the unit banks and an external data pin, wherein the second piece of data is stored into the second bank area after storing of the first piece of data in the first bank area, wherein the first bank area is adjacent to the data input/output unit, and wherein the second bank area is far from the data input/output unit.

In accordance with embodiments of the present invention, data outputted from a unit bank and corresponding to a plurality of bits is divided in units of bits and is stored in bank areas that are at different positions during a read operation, so that it is possible to reduce read latency and to perform high speed operations.

### BRIEF DESCRIPTION OF THE DRAWINGS

FIG. 1 is a configuration diagram of a semiconductor memory device according to an embodiment of the present invention.

FIG. 2 is a configuration diagram of a semiconductor memory device according to another embodiment of the present invention.

FIG. 3 is a timing diagram for explaining an operation of a unit bank adjacent to a data input/output unit illustrated in FIG. 2.

FIG. 4 is a timing diagram for explaining an operation of a unit bank relatively far from a data input/output unit illustrated in FIG. 2.

### DETAILS DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

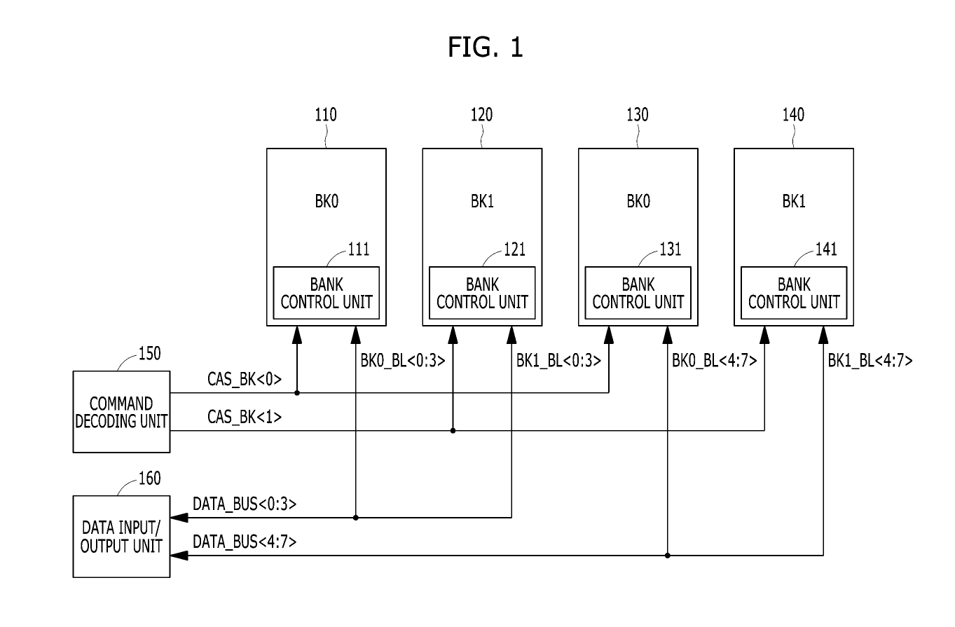

FIG. 1 is a configuration diagram of a semiconductor memory device according to an embodiment of the present invention.

Referring to FIG. 1, the semiconductor memory device may include first to fourth bank areas 110 to 140, a command decoding unit 150, and a data input/output unit 160.

Among the first to fourth bank areas 110 to 140, the first and third bank areas 110 and 130 may be a single unit bank, for example, a first unit bank BK0, and the second and fourth bank areas 120 and 140 may also be another single unit bank, for example, a second unit bank BK1. That is, a single unit bank may be divided into two bank areas for arrangement. Accordingly, during the read and write operation of the first unit bank BK0 and the second unit bank BK1, data may be transferred through a plurality of bit lines BL<0:7> distributed to unit banks, or the first unit bank BK0 of the first and third bank areas 110 and 130 and the second unit bank BK1 of the second and fourth bank areas 120 and 140.

The first to fourth bank areas 110 to 140 may respectively include bank control units 111 to 141 for sensing data from a corresponding bank and outputting the data, and controlling data inputted from an exterior to be written in a corresponding bank in a read or write operation.

Each of the bank control units 111 to 141 may be a sense amplification unit for sensing and outputting data from a corresponding bank area to an exterior (e.g. a controller, host, etc.) during the read operation, and a write driver for controlling data provided from an exterior to be written in a corresponding bank area during the write operation.

The command decoding unit 150 may generate column access signals CAS_BK<0> and CAS_BK<1 respectively corresponding to the first unit bank BK0 and the second unit bank BK1 in response to a command inputted from an exterior during the read or write operation.

During the read operation or the write operation for the first unit bank BK0, the command decoding unit 150 may output the first column access signal CAS_BK<0> corresponding to the first unit bank BK0 and transmit the first column access signal CAS_BK<0> to the first and third bank areas 110 and 130. During the read operation or the write operation for the second unit bank BK1, the command decoding unit 150 may output the second column access signal CAS_BK<1> corresponding to the second unit bank BK1 and transmit the second column access signal CAS_BK<1> to the second and fourth bank areas 120 and 140.

The data input/output unit 160 may transfer data between an external data pin DQ and the first to fourth bank areas 110 to 140 through a first data bus DATA_BUS<0:3> and a second data bus DATABUS<4:7>.

The first data bus DATA_BUS<0:3> may be coupled between the data input/output unit 160 and the first and second bank areas 110 and 120 to transmit/receive data BK0_BL<0:3> and BK1_BL<0:3>, and the second data bus DATA_BUS<4:7> may be coupled between the data input/output unit 160 and the third and fourth bank areas 130 and 140 to transmit/receive data BK0_BL<4:7> and BK1_BL<4:7>. For example, during the read operation for the first unit bank BK0, the data input/output unit 160 may output the data BK_BL<0:3> of the first unit bank BK0 from the first bank area 110 through the first data bus DATA_BUS<0:3>, and may output the BK_BL<4:7> of the first unit bank BK0 from the third bank area 130 through the second data bus DATA_BUS<4:7>.

Hereinafter, a read operation of the semiconductor memory device according to embodiment of the present invention will be described.

During the read operation, the command decoding unit 150 enables column access signals CAS_BK<0> and CAS_BK<1> for a corresponding unit bank in response to a read command inputted from an exterior. For example, during the read operation for the first unit bank BK0, the command decoding unit 150 may enable the first column access signal CAS_BK<0> corresponding to the first unit bank BK0. Then, each of the first and third bank areas 110 and 130 of the first unit bank BK0 may transfer data stored therein to the data input/output unit 160 through the first and second data buses DATA_BUS<0:3> and DATA_BUS<4:7> under the control of the bank control units 111, and 131 and the data input/output unit 160 may output the received data to an exterior. The first bank area 110 may output the data BK0_BL<0:3> of the first unit bank BK0 through the first data bus DATA_BUS<0:3>, and the third bank area 130 may output the data BK0_BL<4:7> of the first unit bank BK0 through the second data bus DATA_BUS<4:7>. Accordingly, the data BK0_BL<0:3> stored in the first bank area 110 adjacent to the data input/output unit 160 may be first outputted, and then the data BK0_BL<4:7> stored in the third bank area 130 relatively far from the data input/output unit 160 may be sequentially outputted due to the difference of physical distance between the first and third bank areas 110 and 130 from the data input/output unit 160. Therefore, according to the related art, the read latency of a bank physically far from the data input/output unit 160 is greater than the read latency of a bank physically adjacent to the data input/output unit 160, thereby having an influence on a high speed operation of the semiconductor memory device.

In accordance with an embodiment of the present invention, among a plurality of pieces of data, data pieces to be first outputted may be stored in a bank area adjacent to the data input/output unit 160 and data pieces to be subsequently outputted may be stored in a bank area relatively far from the data input/output unit 160. In accordance with an embodiment of the present invention, a single unit bank is divided into two bank areas and data piece to be first outputted is stored in a bank area adjacent to the data input/output unit 160 while data piece to be subsequently outputted is stored in a bank area relatively far from the data input/output unit 160, so that it is possible to reduce read latency. Consequently, it is possible to improve the performance of the semiconductor memory device without affecting high speed operation thereof.

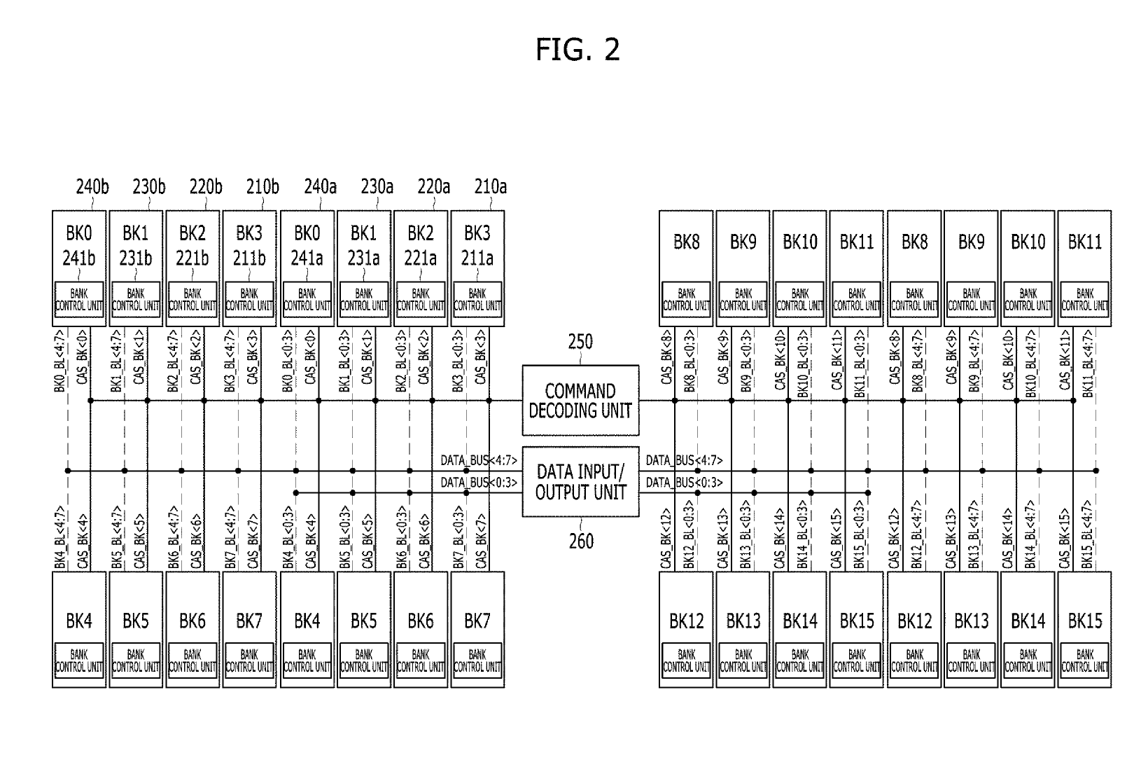

FIG. 2 is a configuration diagram of a semiconductor memory device according to another embodiment of the present invention.

Referring to FIG. 2, the semiconductor memory device may include a plurality of unit banks BK0 to BK15 each including a first bank area and a second bank area, a command decoding unit 250, and a data input/output unit 260.

The command decoding unit 250 and the data input/output unit 260 may have substantially the same configuration as the command decoding unit 150 and the data input/output unit 160 illustrated in FIG. 1 and may perform substantially the same operations.

The unit banks BK0 to BK15 may be two-dimensionally arranged about the data input/output unit 260, the first bank areas of the unit banks BK0 to BK15 may be arranged adjacent to the data input/output unit 260 while the second bank areas of unit banks BK0 to BK15 may be relatively far from the data input/output unit 260.

For convenience, the first to fourth unit banks BK0 to BK3 will be representatively described.

The first to fourth unit banks BK0 to BK3 may respectively include first bank areas 240a, 230a, 220a, and 210a, and second bank areas 240b, 230b, 220b, and 210b. The first bank areas 240a, 230a, 220a, and 210a may store data BKN_BL<0:3>, which are lower bits of a bit group BKN_BL<0:7>, and may be coupled to a first data bus DATA_BUS<0:3>. The second bank areas 240b, 230b, 220b, and 210b may store data BKN_BL<4:7>, which are upper bits of the bit group BKN_BL<0:7> and may be coupled to a second data bus DATA_BUS<4:7>. The first bank areas 240a, 230a, 220a, and 210a may be adjacent to the data input/output unit 260 while the second bank areas 240b, 230b, 220b, and 210b may be relatively far from the data input/output unit 260.

The first bank areas 240a, 230a, 220a, and 210a and the second bank areas 240b, 230b, 220b, and 210b may respectively include bank control units 241a, 241b, 231a, 231b, 221a, 221b, 211a, and 211b. Each of the plurality of bank control units 241a, 241b, 231a, 231b, 221a, 221b, 211a, and 211b may have substantially the same configurations as the plurality of bank control units 111 to 141 and perform substantially the same operations, therefore a detailed descriptions thereof will be omitted.

In the related art, a plurality of unit banks are not divided into first and second bank areas. Therefore, the read latency of a unit bank physically far from the data input/output unit 260 is greater than the read latency of a unit bank physically adjacent to the data input/output unit 260, thereby affecting high speed operations. In accordance with another embodiment of the present invention, in the two-dimensional arrangement about the data input/output unit 260, the first bank area of each unit bank may be adjacent to the data input/output unit 260 as compared with the second bank area. In accordance with another embodiment of the present invention, a single unit bank may be divided into first and second bank areas. Among a plurality of pieces of data, data pieces to be first outputted may be stored in a first bank area adjacent to the data input/output unit 260 and data pieces to be subsequently outputted may be stored in the second bank area relatively far from the data input/output unit 260. Therefore, it is possible to reduce read latency, resulting in the improvement of the performance of the semiconductor memory device.

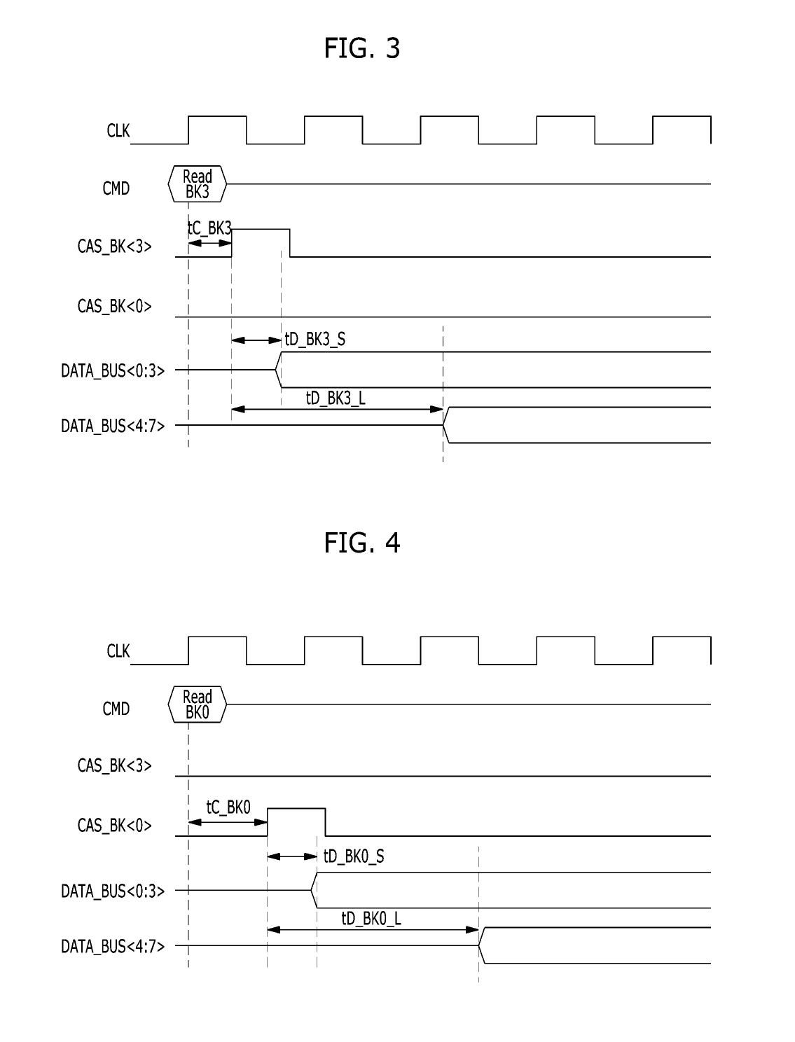

FIG. 3 is a timing diagram for explaining an operation of the unit bank BK3 adjacent to the data input/output unit illustrated in FIG. 2.

Referring to FIGS. 2 and 3, when a read command CMD corresponding to the fourth unit bank BK3 is inputted from an exterior in synchronization with an external clock signal CLK, the command decoding unit 250 may generate a fourth column access signal CAS_BK<3> corresponding to the fourth unit bank BK3 after a command transmission time tC_BK3.

When the fourth column access signal CAS_BK<3> is enabled, the first bank area 210a of the fourth unit bank BK3 may output a piece of data BK3_BL<0:3> corresponding to lower bits stored therein through the first data bus DATA_BUS<0:3> after a data transfer time tD_BK0_S, and the second bank area 210b of the fourth unit bank BK3 may output the other piece of data BK3_BL<4:7> corresponding to upper bits stored therein through the second data bus DATA_BUS<4:7> after a predetermined time tD_BK3_L.

In other words, the data BK3_BL<0:7> corresponding to a plurality of bits stored in the fourth unit bank BK3 may be separately stored into the first and second bank areas 210a and 210b through the first and second data buses DATABUS<0:3> and DATA_BUS<4:7> so that a piece of the data BK3_BL<0:3> to be first outputted and may be stored in a bank area adjacent to the data input/output unit 260 and the other piece of the data BK3_BL<4:7> to be subsequently outputted may be stored in a bank area relatively far from the data input/output unit 260 as compared with the data BK3_BL<0:3>.

FIG. 4 is a timing diagram for explaining an operation of the unit bank BK0 relatively far from the data input/output unit illustrated in FIG. 2.

Referring to FIGS. 2 and 4, when a read command CMD corresponding to the first unit bank BK0 is inputted from an exterior in synchronization with an external clock signal CLK, the command decoding unit 250 may generate a first column access signal CAS_BK<0> corresponding to the first unit bank BK0 after a command input time tC_BK0.

When the first column access signal CAS_BK<0> is enabled, the first bank area 240a of the first unit bank BK0 may output a piece of data BK0_BL<0:3> corresponding to lower bits stored therein through the first data bus DATA_BUS<0:3> after a data transfer time tD_BK0_S, and the second bank area 240b of the first unit bank BK0 may output the other piece of data BK0_BL<4:7> corresponding to upper bits stored therein through the second data bus DATA_BUS<4:7> after a predetermined time tD_BK0_L.

In other words, the data BK0_BL<0:7> corresponding to a plurality of bits stored in the first unit bank BK0 may be separately stored into the first and second bank areas 240a and 240b through the first and second data buses DATABUS<0:3> and DATA_BUS<4:7> so that a piece of the data BK0_BL<0:3> to be first outputted may be stored in a bank area adjacent to the data input/output unit 260, and the other piece of the data BK0_BL<4:7> to be subsequently outputted may be stored in a bank area relatively far from the data input/output unit 260 as compared with the data BK0_BL<0:3>.

Referring again to FIGS. 3 and 4, in the case of the fourth unit bank BK3 adjacent to the data input/output unit 260, read latency, which is a time until first data is outputted through the first data bus DATA_BUS<0:3> after the read command CMD is inputted, may not be dramatically reduced. However, in the case of the first unit bank BK0 remotest from the data input/output unit 260, the data BK0_BL<0:3> to be firstly outputted is stored in a bank area adjacent to the data input/output unit 260 so that the command input time tC_BK0 and the data transfer time tD_BK0_S are reduced, resulting in the reduction of the read latency until the first data is outputted. When all unit banks relatively far from the data input/output unit 260 separately store a data piece to be first outputted and the other data piece to be subsequently outputted in a near bank area and a relatively far bank area, respectively, the read latency may be reduced as compared with the related art, so that it is possible to perform a read operation.

Consequently, the semiconductor memory devices according to the embodiments of the present invention can perform a high speed operation as the read latency is reduced, resulting in improved performance.

Although various embodiments have been described for illustrative purposes, it will be apparent to those skilled in the art that various changes and modifications may be made without departing from the spirit and scope of the invention as defined in the following claims.

What is claimed:

1. A semiconductor memory device comprising:
a data input/output unit suitable for storing a plurality of pieces of data in a plurality of bank areas through a first data bus and a second data bus, and outputting the plurality of pieces of data to an external data pin from the plurality of bank areas; and
a plurality of unit banks each including a first bank area which stores data corresponding to a lower bit of a bit group to be first inputted/outputted though the first data bus, and a second bank area which stores data corresponding to an upper bit of the bit group to be inputted/outputted though the second data bus after input/output of the data corresponding to the lower bit,
wherein the first bank area of each of the plurality of unit banks is adjacent to the data input/output unit as compared with the second bank area of each of the plurality of unit banks.

2. The semiconductor memory device of claim 1, further comprising a bank control unit suitable for controlling each of the first and second bank areas to output the data corresponding to the lower bit and the upper bit to the data input/output unit, or to receive data from the data input/output unit.

3. The semiconductor memory device of claim 2, wherein the bank control unit includes a sense amplification unit suitable for sensing a level of data stored in a corresponding bank area and transferring the sensed data to the data input/output unit during the read operation.

4. The semiconductor memory device of claim 2, wherein the bank control unit includes a write driver suitable for writing data received from the data input/output unit in a corresponding bank area during a write operation.

5. The semiconductor memory device of claim 1 further comprising a command decoding unit suitable for generating a column access signal corresponding to a corresponding unit bank in response to a read command or a write command.

6. A semiconductor memory device comprising:
a data input/output unit suitable for storing a plurality of pieces of data in a plurality of bank areas through a first data bus and a second data bus, and outputting the plurality of pieces of data to an external data pin from the plurality of bank areas;
a first bank area arranged at a first distance from the data input/output unit, and suitable for storing data corresponding to a first bit of a first bit group though the first data bus;
a second bank area arranged at a second distance from the data input/output unit, and suitable for storing data corresponding to a first bit of a second bit group though the first data bus;
a third bank area arranged at a third distance from the data input/output unit, and suitable for storing data corresponding to a second bit of the first bit group though the second data bus; and
a fourth bank area arranged at a fourth distance from the data input/output unit, and suitable for storing data corresponding to a second bit of the second bit group though the second data bus,
wherein the first to fourth distances are greater in order and the data corresponding to the first bit of the first and second bit groups includes data that is first inputted/outputted.

7. The semiconductor memory device of claim 6, wherein the first and third bank areas are included in a first unit bank.

8. The semiconductor memory device of claim 6, wherein the second and fourth bank areas are included in a second unit bank.

9. The semiconductor memory device of claim 6, wherein the first bit of the first and second bit groups is a lower bit of the corresponding bit group.

10. The semiconductor memory device of claim 6, wherein the second bit of the first and second bit groups is an upper bit of the corresponding bit group.

11. The semiconductor memory device of claim 6, wherein each of the first to fourth bank areas comprises a bank control unit suitable for controlling data corresponding to the first bit group and the second bit group to be outputted to the data input/output unit, or controlling data to be received from the data input/output unit.

12. The semiconductor memory device of claim 11, wherein the bank control unit includes a sense amplification unit suitable for sensing data stored in a corresponding bank area and transferring the sensed data to the data input/output unit during the read operation.

13. The semiconductor memory device of claim 11, wherein the bank control unit includes a write driver suitable for writing data received from the data input/output unit in a corresponding bank area during a write operation.

14. The semiconductor memory device of claim 12, wherein the first and second bank areas output the data corresponding to the first bit of the first and second bit groups before the data corresponding to the second bit of the first and second bit groups.

15. The semiconductor memory device of claim 6, further comprising a command decoding unit suitable for generating a column access signal to a corresponding unit bank in response to a read command or a write command.

16. A semiconductor memory device comprising:
a plurality of unit banks each including first and second bank areas storing first and second pieces of data, respectively; and
a data transfer unit suitable for transferring the first and second pieces of data between the unit banks and an external data pin,
wherein the second piece of data is read out subsequently to the first piece of data,
wherein the first bank area is adjacent to the data input/output unit, and
wherein the second bank area is relatively far from the data input/output unit.

17. A semiconductor memory device comprising:
a plurality of unit banks each including first and second bank areas storing first and second pieces of data respectively; and
a data transfer unit suitable for transferring the first and second pieces of data between the unit banks and an external data pin,
wherein the second piece of data is stored into the second bank area after storing of the first piece of data in the first bank area,
wherein the first bank area is adjacent to the data input/output unit, and
wherein the second bank area is far from the data input/output unit.
